(19) United States
(12) Patent Application Publication
(10) Pub. No.: US 2026/0062025 A1
(43) Pub. Date: Mar. 5, 2026

(54) TRANSPARENT OPERATOR IMPAIRMENT DETECTION FOR A MOTOR VEHICLE

(71) Applicant: GM Global Technology Operations LLC, Detroit, MI (US)

(72) Inventors: Siddhartha Gupta, Rochester Hills, MI (US); Senthil Karuppaswamy, Rochester Hills, MI (US); Mitesh Lalwala, Sterling Heights, MI (US); Alok Warey, Novi, MI (US)

(21) Appl. No.: 18/825,843

(22) Filed: Sep. 5, 2024

(51) Int. Cl. B60W 50/14; B60W 40/08; G06V 10/82; G06V 20/56; G06V 40/10; G06V 40/20

(52) U.S. Cl. CPC B60W 50/14; B60W 40/08; G06V 10/82; G06V 20/56; G06V 40/10; G06V 40/25; B60W 2040/0809; B60W 2040/0818; B60W 2050/143; B60W 2050/146; B60W 2420/403; B60W 2420/408; B60W 2540/043; B60W 2540/229; B60W 2540/24; B60W 2540/26

(57) ABSTRACT

An impairment detection process includes detecting an approach of an operator to a machine. The approach is monitored to determine a set of gait parameters of the operator based on an output of a set of gait sensors. The set of gait parameters is provided to a long short term memory (LSTM) recurrent neural network which determines a gait score by regressing the set of gait parameters. The gait score is compared to an impairment threshold, and the operator is engaged in response to the gait score exceeding the impairment threshold.

### INTRODUCTION

The subject disclosure relates to impairment detection for vehicle operators, and more particularly to transparently identifying potential impairment of a vehicle operator.

Operation of motor vehicles while impaired due to chemical substances (e.g. alcohol) or medical episodes can lead to improper and undesirable operation of the vehicle. In order to prevent improper operation, some vehicles include active systems with the goal of identifying impaired vehicle operators. One such system in public use is an ignition interlock system which requires a breathalyzer analysis to activate a vehicle ignition.

In some cases, it is desirable for such systems to be as transparent to the vehicle operator as possible. The transparency of the system refers to how aware the vehicle operator is of the system and how much direct interaction is required between the vehicle operator and the system. In the case of an impairment detection system, a greater transparency can decrease an ability of the vehicle operator to attempt to circumvent the system and can provide more holistic detections allowing the system to identify instances of impairment that the vehicle operator may not be aware of (e.g., a medical episode).

As such, it is desirable to provide a vehicle system that automatically identifies potential impairment in a vehicle operator in a transparent manner and while the vehicle operator is exterior to the vehicle.

### SUMMARY

In one exemplary embodiment an impairment detection process includes detecting an approach of an operator to a machine. The approach is monitored to determine a set of gait parameters of the operator based on an output of a set of gait sensors. The set of gait parameters is provided to a long short term memory (LSTM) recurrent neural network which determines a gait score by regressing the set of gait parameters. The gait score is compared to an impairment threshold, and the operator is engaged in response to the gait score exceeding the impairment threshold.

In addition to one or more of the features described herein the impairment detection process is transparent to the operator when the gait score is less than the impairment threshold.

In addition to one or more of the features described herein detecting the approach of the operator comprises by one of detecting a position of at least one token object carried by the operator relative to the machine, detecting a remote activation of at least one function of the machine, and confirming a person who has approached as the operator by the person interacting with the machine.

In addition to one or more of the features described herein detecting the approach of the operator comprises confirming a person who has approached as the operator by the person interacting with the machine, wherein a distinct gait score is determined for all approaching persons and wherein the gait score compared to the impairment threshold is the gait score corresponding to the confirmed operator.

In addition to one or more of the features described herein determining the set of gait parameters of the operator based on an output of a set of gait sensors comprises isolating at least one gait parameter from the output of the set of gait sensors using at least one of a convolutional neural network (CNN), a Gait Energy Image (GEI) classification module, a Convolutional LSTM, a vision transformer, a graph neutral network, a Bayesian Network, a Deep Gaussian Process module, a multimodal LLM, a vision language models, and a rules based physiological image analysis.

In addition to one or more of the features described herein the set of gait parameters includes speed consistency, stride length, body sway, upper body bend, lower body bend and route of travel.

In addition to one or more of the features described herein the set of gait sensors includes at least one camera and at least one ranging sensor.

In addition to one or more of the features described herein the at least one ranging sensor is a light detection and ranging (LIDAR) sensor.

In addition to one or more of the features described herein engaging with the operator in response to the gait score exceeding the impairment threshold comprises outputting one of a text notification and an audio notification to the operator in response to the gait exceeding the impairment threshold by any amount.

In addition to one or more of the features described herein engaging with the operator in response to the gait score exceeding the impairment threshold comprises engaging the operator using at least one secondary impairment detection system.

In addition to one or more of the features described herein, the process further includes responding to the secondary impairment detection system providing an impairment detection below a secondary detection threshold by detecting a fatigued state of the operator and placing the machine in an alertness state, the alertness state including at least one of louder notifications, larger text on at least one display screen, higher contrast on the at least one display screen, and increased brightness on the at least one display screen.

In addition to one or more of the features described herein, the process further includes responding to the secondary impairment detection system providing an impairment detection above a secondary detection threshold by disabling at least one machine system.

In addition to one or more of the features described herein engaging with the operator in response to the gait score exceeding the impairment threshold comprises disabling at least one machine system in response to the gait score exceeding the impairment threshold by a maximum impairment amount.

In addition to one or more of the features described herein the machine is a motor vehicle and wherein the operator is a driver of the motor vehicle.

In another exemplary embodiment a motor vehicle includes a controller having a gait detection module and at least one impaired operation prevention module. A set of sensors is in communication with the controller and is configured to sense an approaching vehicle operator. The gait detection module is configured to detect the approaching vehicle operator, determine a set of gait parameters of the approaching vehicle operator based on an output of the set of gait sensors and regress the set of gait parameters over time using a long short term memory (LSTM) recurrent neural network to determine a gait score. The gait score is compared to an impairment threshold and the vehicle operator is engaged using the at least one impaired operation prevention module in response to the gait score exceeding the impairment threshold.

In addition to one or more of the features described herein determining the set of gait parameters of the approaching vehicle operator based on an output of a set of gait sensors comprises isolating at least one gait parameter from the output of the set of gait sensors using at least one of a convolutional neural network (CNN), a Gait Energy Image (GEI) classification module, a Convolutional LSTM, a vision transformer, a graph neutral network, a Bayesian Network, a Deep Gaussian Process module, a multimodal LLM, a vision language models, and a rules based physiological image analysis.

In addition to one or more of the features described herein the set of gait parameters includes parameters includes speed consistency, stride length, body sway, upper body bend, lower body bend and route of travel.

In addition to one or more of the features described herein the set of gait sensors includes at least one camera and at least one ranging sensor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic representation of a motor vehicle;

FIG. 2 depicts a combined view of a vehicle operator approach and a gait monitoring system of the motor vehicle;

FIG. 3 is a flowchart of an operation of an impairment detection system of the motor vehicle;

FIG. 4 depicts sequential operations of a long short term memory (LSTM) recurrent neural network detecting a motor vehicle operator in an impaired condition;

FIG. 5 illustrates a set of motor vehicle operator states for detecting gait using a physiological analysis of the motor vehicle operator; and

FIG. 6 illustrates an integration of the motor vehicle gait detection with an impairment detection and response system of the motor vehicle.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment methods, devices and systems are provided for implementing a transparent impairment detection system for a motor vehicle. The impairment detection system uses sequential images and other sensor readings of a motor vehicle operator approaching the vehicle to analyze a gait of the motor vehicle operator. The gait of the motor vehicle operator refers to the manner of walking of the vehicle operator and is inclusive of speed consistency, stride length, body sway, upper body bend, lower body bend and route of travel.

The gait is assigned a gait score representative of how likely the motor vehicle operator is to be currently impaired. When the gait score exceeds a predefined set of standards (e.g., a gait threshold), the vehicle responds by using one or more incorporated systems to notify the vehicle operator that they are likely impaired. In some embodiments the vehicle further activates one or more vehicle systems to prevent an impaired motor vehicle operator from operating the vehicle.

Embodiments described herein present numerous advantages and technical effects. Included among the advantages and technical effects is an ability to transparently identify potential impairment of a vehicle operator prior to direct engagement with the vehicle by the vehicle operator.

The embodiments are not limited to use with any specific vehicle and may be applicable to various additional contexts. For example, the transparent impairment detection may be incorporated into other heavy machinery including construction equipment, stationary machinery, or any similar system.

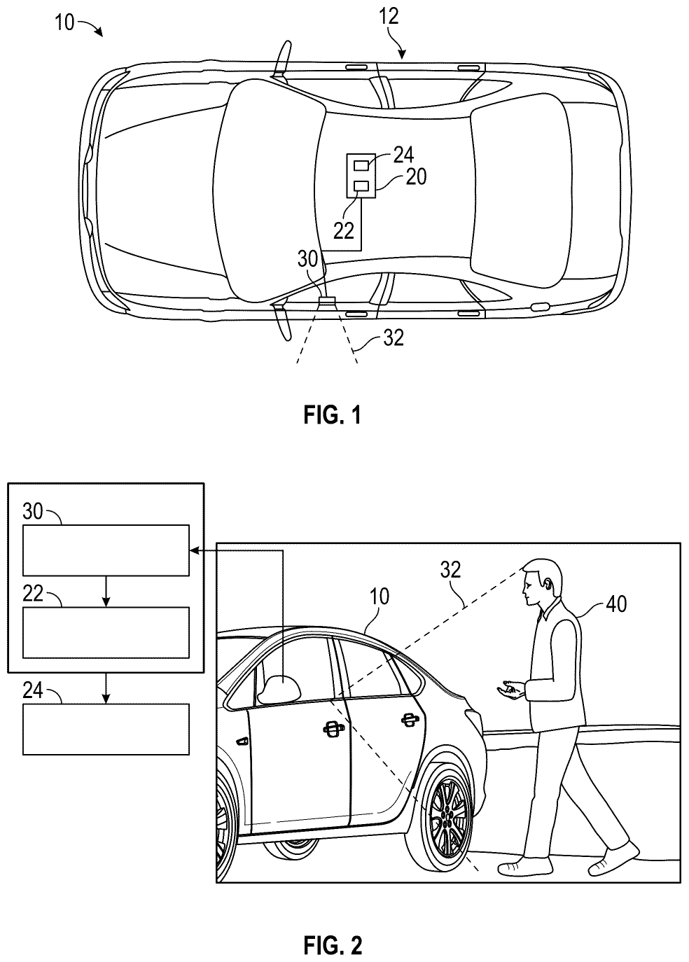

FIG. 1 illustrates an exemplary vehicle 10 including a vehicle body 12. FIG. 2 illustrates an isometric view of the vehicle 10 and an approaching vehicle operator 40. A vehicle controller 20 is disposed in the vehicle 10 and includes a gait monitoring module 22 and one or more impaired operation prevention systems 24. While illustrated in the vehicle 10 of FIG. 1 as a single dedicated controller 20, it is appreciated that in alternate examples the controller 20 may be a general vehicle controller, multiple control systems distributed about the vehicle 10 and operating in conjunction with each other, a remote controller in communication with the vehicle 10, and/or any similarly ranged control configuration.

One or more gait detection sensors 30 are arranged about the vehicle 10 and configured to monitor an approach of the vehicle operator 40. The detections from the gait detection sensors 30 are provided to the gait monitoring module 22 within the controller 20. The gait monitoring module detects an impaired gait using either a statistical analysis of physiological parameters detected using sensor outputs and image processing, a machine learning process trained on sequential images generated of impaired people, or a combination of the two. When the gait monitoring module 22 detects impairment a notification is provided to one or more impaired operation prevention system systems 24, thereby allowing the systems 24 to respond accordingly. In the illustrated example, the gait sensors 30 are focused on a driver side door zone 32 in order to save processing resources of the controller 20. In other examples, the gait sensors 30 can monitor a larger zone, up to a full circumference of the vehicle 10.

In one example, the gait detection sensors 30 include imaging devices such as cameras and ranging systems such as light and distance ranging (LiDAR) systems.

In another example, the gait detection sensors 30 can include one or more sensors from other vehicle systems such as mirror replacement systems, object detection and recognition systems, and any similar vehicle systems including relevant sensor types. In such an example, the outputs of the shared sensors are provided to all relevant vehicle systems via a data sharing system such as a controller area network (CAN) system.

In one example, the controller 20 detects the approach of the vehicle operator 40 by detecting a relative position of a key fob, operator's mobile phone, or any similar token object carried by the vehicle operator 40. In another example, the controller 20 detects the approach of the vehicle operator 40 in response to a remote initiation of one or more vehicle system such as a remote door unlock and/or a remote ignition system.

In another example, the controller 20 analyzes the approach of any person and engages the systems 24 when an approaching person has an impaired gait and is confirmed to be the vehicle operator 40 by interacting with the vehicle 10 in certain specified ways. By way of example, the vehicle operator 40 can be confirmed when the approaching person opens the a drive side door, attempts to start the vehicle 10, enters the vehicle 10, sits in a driver's seat, or performs any similar action corresponding to being a vehicle operator 40.

With continued reference to FIGS. 1-2, FIG. 3 illustrates high level process 300 for operating the gait detection module 22 of the controller 20 using a machine learning based process. Initially the process 300 begins operating in response to detecting an approaching vehicle operator 40 at a step 310.

Subsequent to initiation of the process 300, the gait detection sensors 30 monitor a gait of the vehicle operator 40 approaching the vehicle 10 in a monitor gait step 320.

During the monitoring, output values such as images and distances provided by the gait detection sensors 30 are provided to the gait detection module 22. The gait detection module 22 then provides the sensor outputs to a machine learning based system such as a Long Short Term Memory (LSTM) recurrent neural network which analyzes the sequential parameter values to determine a gait score corresponding to the gait of the vehicle operator 40. The LSTM recurrent neural network is trained using video feeds of gaits of multiple people at multiple distinct levels of impairment.

As the vehicle operator 40 approaches the vehicle 10 and the analysis is iterated, the LSTM converges on a single GAIT score and the converged gait score is compared to an impairment threshold in a gait impaired check 330. When the gait score does not exceed an impairment threshold (no) the process 300 allows the vehicle operator 40 to continue with vehicle operations as normal with no notification to the vehicle operator 40 that an impairment check was performed in an allow vehicle operations step 340. The process 300 is fully transparent to the vehicle operator 40 when no impairment is detected.

When the gait score exceeds the impairment threshold in the gait impaired check 330 (yes), the process 300 proceeds to engage with the vehicle operator 40 in an engage vehicle operator step 350. The engagement can take the form of a warning provided to the vehicle operator 40 that the vehicle operator 40 may be impaired, activation of one or more additional vehicle systems 24 such as an ignition interlock device, and/or actively disabling one or more functions of the vehicle 10.

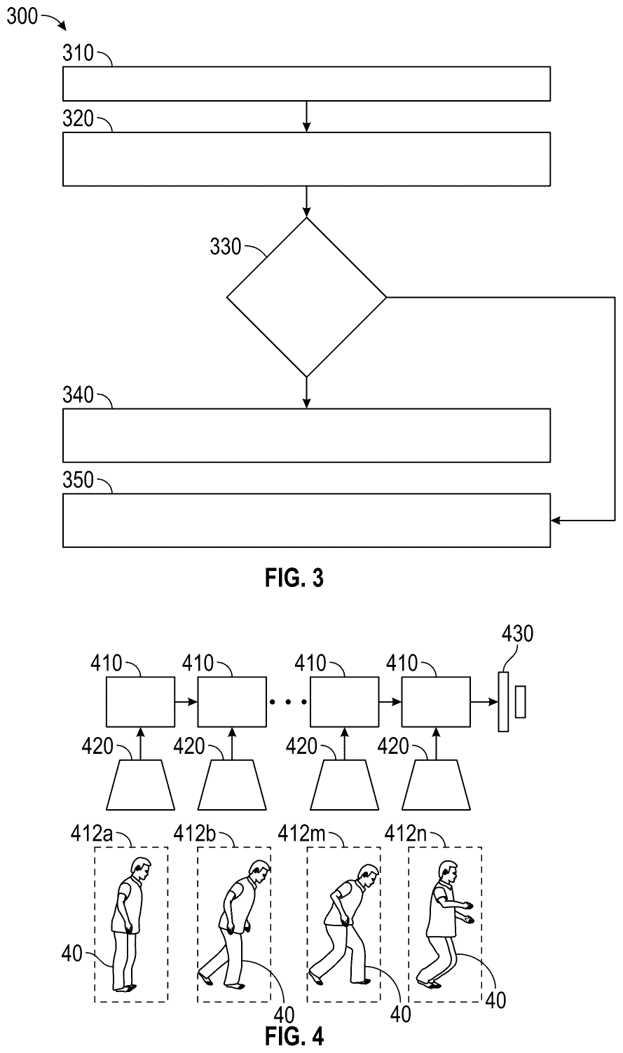

With continued reference to FIG. 3, FIG. 4 illustrates the operation of one example gait impairment detection using an LSTM to process sequential images 412a, 412b, 412m, 412n of the vehicle operator 40. Each of the images 412a, 412b, 412m, 412n is analyzed using a convolutional neural network (CNN 420) to isolate the vehicle operator 40 and identify one or more features from the image 412a, 412b, 412m, 412n. The determined features of each image 412a, 412b, 412m, 412n and/or each pair of sequential image 412a, 412b, 412m, 412n are provided to the LSTM 410 which uses the features to identify learned parameters corresponding to an impaired gait. As discussed above, the LSTM is trained on multiple distinct individuals at multiple distinct levels of impairment. The LSTM 410 provides the learned parameters to a neural network analysis portion 430 which regresses the learned parameters of the sequential images over time in order to determine how likely the vehicle operator 40 is to be impaired.

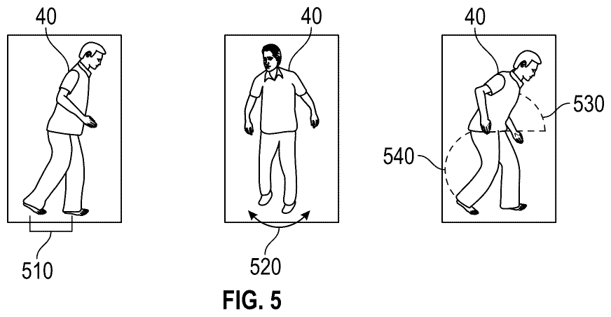

FIG. 5 illustrates multiple gait parameters of the vehicle operator 40 that can be physiologically measured and are indicative of potential impairment. The physiological measurements of FIG. 5 can be processed using a statistical analysis including established impairment rules, to determine a physiological measurement based gait impairment score. The gait parameters include a stride length 510, a body sway 520, an upper bend 530 at the waist of the vehicle operator 40 and a lower bend 540 at the knees of the vehicle operator 40. In alternate examples depending on the available sensors and the positioning of the available gait detection sensors 30 additional impaired gate parameters may be detected.

In some alternate examples, the physiological measurements may be further input into the LSTM 410 along with the corresponding images 412a, 412b, 412m, 412n, thereby providing for a combined physiological and machine learning based gait score.

In yet further examples, the controller 20 may include additional machine learning processes configured to profile the vehicle operator's unimpaired gait, as well as one or more instances of an impaired gait, further allowing the controller 20 to recognize an impaired and a non-impaired gait of a particular vehicle operator. This recognition can further be applied by the controller 20 to distinguish between the vehicle operator and other pedestrians or people that may be approaching the vehicle 10.

In yet further examples, one or more gait parameters may be detected using alternate systems including Gait Energy Image (GEI) classification, Convolutional LSTMs, vision transformers, graph neutral networks, Bayesian Networks, Deep Gaussian Processes, multimodal LLMs and vision language models, and/or rules based image analysis. In some examples multiple gait parameter detection systems can be used in conjunction to detect different parameters and provide the detected parameters to the LSTM 410.

The gait detection module 22 is, in some examples, configured to detect impairment in a cause agnostic manner. As such, the gait detection module 22 is able to detect impairment from alcohol or other chemical substances and impairment that may occur as the result of a medical condition (e.g., a stroke) to which the vehicle operator 40 may be unaware or which the vehicle operator 40 may be unaware of the severity of the resulting impairment.

In some examples, the process of FIG. 3 may be modified to include additional checks directed to a level of impairment such that the module 22 can provide increasingly strict responses as the gait impairment score increases. By way of example, the engage vehicle operator step 350 may stop at providing a warning to the vehicle operator 40 when the gait impairment score is slightly above a threshold, activate active impairment checks (e.g. an ignition interlock) when the gait impairment score is above the threshold, but below a maximum threshold, and prevent operation of the vehicle by the vehicle operator 40 entirely when the threshold is above the maximum threshold.

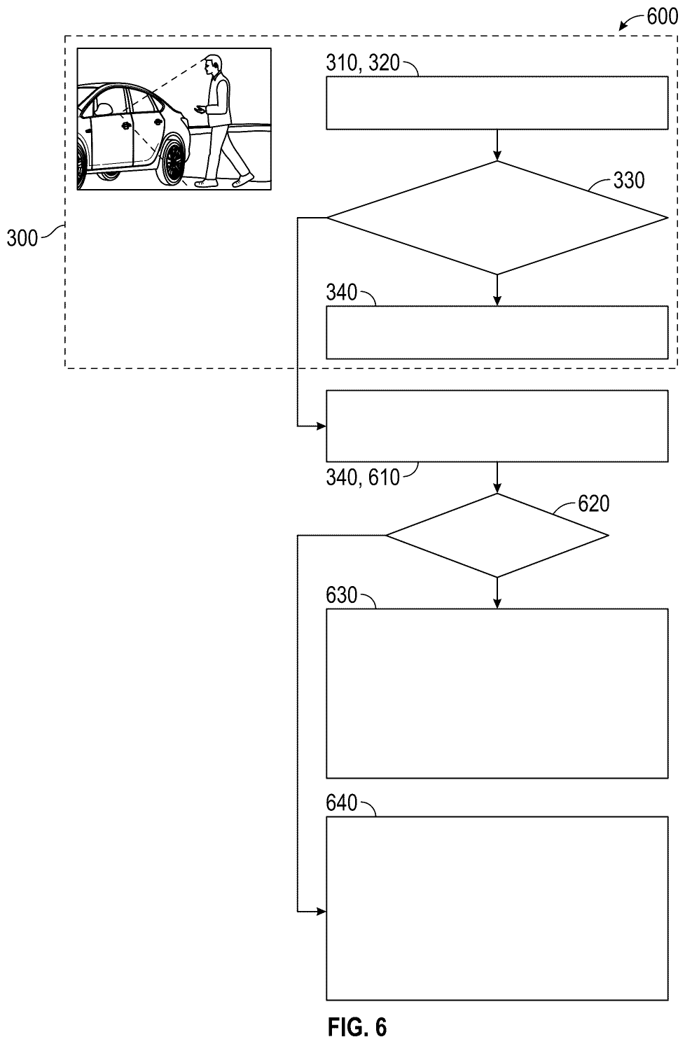

With continued reference to FIGS. 1-5, FIG. 6 illustrates a process 600 integrating the process 300 of FIG. 3 with a specific vehicle system including an ignition interlock. When the process 600 proceeds to the engage vehicle operator step 340, 610, the vehicle operator 40 is instructed to provide a breath sample to the ignition interlock to confirm an allowable blood alcohol content (BAC) level. During this step 340, 610, the controller 20 maintains the vehicle 10 in a no shift, no drive state that prevents the vehicle 10 from being operated at all.

The ignition interlock compares the detected BAC to a BAC limit in a BAC check 620. When the detected BAC is below the limit, but the gait impairment was still detected, the process 600 proceeds to inform the vehicle operator 40 that the detected BAC is below the limit in a notify vehicle operator step 630. Simultaneously, the controller 20 notifies the vehicle operator 40 of potential fatigue and enables operation of the vehicle 10. In some cases, one or more alertness or awareness systems is activated when the vehicle 10 is allowed to be operated. The awareness systems may include, in some examples, louder notifications, larger text, higher contrast, and brighter information screens.

Once the vehicle operator 40 begins operating the vehicle 10, the vehicle operator 40 is continuously monitored using existing driver monitoring systems. As operation continues, when the vehicle operator 40 establishes an alert driving profile the one or more alertness or awareness modules may be turned off or have their intensity decreased.

When the BAC check 620 indicates that the vehicle operator 40 has a BAC above the threshold, the vehicle operator 40 is warned that their BAC exceeds the threshold and operations of the vehicle 10 are disabled in a disable vehicle step 640. In some examples, the vehicle 10 may include an emergency override by which the vehicle operator 40, or a proxy operator, may override the lockout and allow the vehicle 10 to be operated.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An impairment detection process comprising:
detecting an approach of an operator to a machine;
determining a set of gait parameters of the operator based on an output of a set of gait sensors;
receiving the set of gait parameters at a long short term memory (LSTM) recurrent neural network and determining a gait score by regressing the set of gait parameters;
comparing the gait score to an impairment threshold; and
engaging with the operator in response to the gait score exceeding the impairment threshold.

2. The process of claim 1, wherein the impairment detection process is transparent to the operator when the gait score is less than the impairment threshold.

3. The process of claim 1 wherein detecting the approach of the operator comprises by one of detecting a position of at least one token object carried by the operator relative to the machine, detecting a remote activation of at least one function of the machine, and confirming a person who has approached as the operator by the person interacting with the machine.

4. The process of claim 3, wherein detecting the approach of the operator comprises confirming a person who has approached as the operator by the person interacting with the machine, wherein a distinct gait score is determined for all approaching persons and wherein the gait score compared to the impairment threshold is the gait score corresponding to the confirmed operator.

5. The process of claim 1, wherein determining the set of gait parameters of the operator based on an output of a set of gait sensors comprises isolating at least one gait parameter from the output of the set of gait sensors using at least one of a convolutional neural network (CNN), a Gait Energy Image (GEI) classification module, a Convolutional LSTM, a vision transformer, a graph neutral network, a Bayesian Network, a Deep Gaussian Process module, a multimodal LLM, a vision language models, and a rules based physiological image analysis.

6. The process of claim 5, wherein the set of gait parameters includes speed consistency, stride length, body sway, upper body bend, lower body bend and route of travel.

7. The process of claim 5, wherein the set of gait sensors includes at least one camera and at least one ranging sensor.

8. The process of claim 7, wherein the at least one ranging sensor is a light detection and ranging (LIDAR) sensor.

9. The process of claim 1, wherein engaging with the operator in response to the gait score exceeding the impairment threshold comprises outputting one of a text notification and an audio notification to the operator in response to the gait exceeding the impairment threshold by any amount.

10. The process of claim 9, wherein engaging with the operator in response to the gait score exceeding the impairment threshold comprises engaging the operator using at least one secondary impairment detection system.

11. The process of claim 10, wherein the at least one secondary impairment detection system includes a breathalyzer testing system.

12. The process of claim 10, further comprising responding to the secondary impairment detection system providing an impairment detection below a secondary detection threshold by detecting a fatigued state of the operator and placing the machine in an alertness state, the alertness state including at least one of louder notifications, larger text on at least one display screen, higher contrast on the at least one display screen, and increased brightness on the at least one display screen.

13. The process of claim 10, further comprising responding to the secondary impairment detection system providing an impairment detection above a secondary detection threshold by disabling at least one machine system.

14. The process of claim 10, wherein engaging with the operator in response to the gait score exceeding the impairment threshold comprises disabling at least one machine system in response to the gait score exceeding the impairment threshold by a maximum impairment amount.

15. The process of claim 1, wherein the machine is a motor vehicle and wherein the operator is a driver of the motor vehicle.

16. The process of claim 1, wherein the process is agnostic to an impairment cause.

17. A motor vehicle comprising:
a controller having a gait detection module and at least one impaired operation prevention module;
a set of sensors in communication with the controller and configured to sense an approaching vehicle operator;
the gait detection module being configured to detect an approaching vehicle operator, determining a set of gait parameters of the approaching vehicle operator based on an output of the set of gait sensors and regressing the set of gait parameters over time using a long short term memory (LSTM) recurrent neural network to determine a gait score, comparing the gait score to an impairment threshold and engaging the vehicle operator using the at least one impaired operation prevention module in response to the gait score exceeding the impairment threshold.

18. The motor vehicle of claim 17, wherein determining the set of gait parameters of the approaching vehicle operator based on an output of a set of gait sensors comprises isolating at least one gait parameter from the output of the set of gait sensors using at least one of a convolutional neural network (CNN), a Gait Energy Image (GEI) classification module, a Convolutional LSTM, a vision transformer, a graph neutral network, a Bayesian Network, a Deep Gaussian Process module, a multimodal LLM, a vision language models, and a rules based physiological image analysis.

19. The motor vehicle of claim 18, wherein the set of gait parameters includes parameters includes speed consistency, stride length, body sway, upper body bend, lower body bend and route of travel.

20. The motor vehicle of claim 17, wherein the set of gait sensors includes at least one camera and at least one ranging sensor.
